(19) United States
(12) Patent Application Publication
(10) Pub. No.: US 2020/0144749 A1
(43) Pub. Date: May 7, 2020

(54) CONNECTOR AND CONNECTOR FIXING STRUCTURE

(71) Applicant: Ying Hao Technology CO., LTD., New Taipei City (TW)

(72) Inventor: Chih-Jung CHEN, New Taipei City (TW)

(73) Assignee: Ying Hao Technology CO., LTD., New Taipei City (TW)

(21) Appl. No.: 16/667,957

(22) Filed: Oct. 30, 2019

(30) Foreign Application Priority Data
Nov. 6, 2018 (TW) 107215095
Jun. 12, 2019 (TW) 108210621

(51) Int. Cl. H01R 12/77; H01R 13/405; H01R 13/24

(52) U.S. Cl. CPC H01R 12/771; H01R 13/24; H01R 13/405

(57) ABSTRACT

A connector fixing structure is disclosed. The connector fixing structure includes a cable and a connector. The cable includes a plurality of conductors. The connector includes a metal shell, an insulting shell, a plurality of terminals positioned on the insulating shell, and a push-pull device configured to be moved toward the plurality of terminals when the cable is positioned inside the insulating shell such that the plurality of conductors presses the plurality of terminals.

### RELATED APPLICATIONS

This application claims the priorities of Taiwanese Patent Application Nos. 107215095, filed on Nov. 6, 2018, and 108210621, filed on Aug. 12, 2019, the contents of which are incorporated herein by reference in its entirety.

### FIELD AND BACKGROUND OF THE INVENTION

The present disclosure relates to a connector fixing structure, and more particularly to a movable connector fixing structure.

As the rapid development of the storage device, a secure digital (SD) memory card has been widely used in the portable device, such as cell phones, digital cameras or multimedia players. Therefore, a portable device often has a connector for placing the SD card. However, the connector is implemented by welding the terminal and the shell on a printable circuit board and thus is difficult to replace.

A cable is a data conductor cable for transferring data between two electronic devices. Generally, a cable is made by multiple conductor lines arranged in parallel. Each conductor line is covered by an insulating layer to independently transfer signals. A flex flat cable (FFC) or a flexible cable (Flex Cable) is a new type of cables, which is made by press fitting an insulating material and a thin copper line with tin plating. The above-mentioned cables can be easily used in all kinds of electronic devices because of some advantages such as orderly-arranged conductor lines, high data transmission rate, low volume, flexibility, and easy assembly. Especially, these flexible cables are widely used between two movable parts because it is bendable. For example, the FFC could be welded on the printable circuit board of the connector such that the signals could be transferred to another device through the flex flat cable (FFC).

However, if the FFC is welded on the printable circuit board of the connector, then the application of the FFC is limited. For example, when the length of the FFC is not long enough and needs to be replaced, the FFC cannot be easily replaced by a longer FFC.

Further, if the connector is used to connect to another electronic device, the printable circuit board needs to be fixed on a substrate of the connector. This increases a process step and a component in the entire manufacturing process.

Therefore, it is essential to effectively and stable connect a flexible cable to a connector to have its convenience.

### SUMMARY OF THE INVENTION

One objective of an embodiment of the present disclosure is to provide a connector fixing structure, to solve the above-mentioned issue.

According to an embodiment of the present disclosure, a connector fixing structure is disclosed. The connector fixing structure includes a cable and a connector. The cable includes a plurality of conductors. The connector includes a metal shell, an insulting shell, a plurality of terminals positioned on the insulating shell, and a push-pull device configured to be moved toward the plurality of terminals when the cable is positioned inside the insulating shell such that the plurality of conductors presses the plurality of terminals.

According to another embodiment of the present disclosure, a connector fixing structure is disclosed. The connector fixing structure comprises a cable and a connector. The cable comprises a plurality of conductors. The connector comprises a shell and a plurality of terminals. The plurality of terminals comprises: a ground terminal, comprising a plurality of external device ground ends and a conductor ground end, wherein each of the plurality of external device grounding ends is configured to connect to a ground pin of an external device and the conductor ground end is configured to connect to one of the plurality of the conductors; a first data terminal, comprising a first external device data end and a first conductor data end, wherein the first external data end is configured to connect to a first data signal pin of the external device and the first conductor data end is configured to connect to one of the plurality of conductors; a pair of first differential signal terminals, each of the first differential signal terminals comprising a first external device differential signal end and a first conductor differential signal end, wherein the first external device differential signal end is configured to connect to a first differential signal pin of the external device and the first conductor differential signal end is configured to connect to one of the plurality of conductors; a command terminal, comprising an external device command end and a conductor command end, wherein the external device command end is configured to connect to a command pin of the external device and the conductor command end is configured to connect to one of the plurality of conductors; a clock terminal, comprising an external device clock end and a conductor clock end, wherein the external device clock end is configured to connect to a clock pin of the external device and the conductor clock end is configured to connect to one of the plurality of conductors; a pair of second differential signal terminals, each of the second differential signal terminals comprising a second external device differential signal end and a second conductor differential signal end, wherein the second external device differential signal end is configured to connect to a second differential signal pin of the external device and the second conductor differential signal end is configured to connect to one of the plurality of conductors; and a second data terminal, comprising a second external device data end and a second conductor data end, wherein the second external data end is configured to connect to a second data signal pin of the external device and the second conductor data end is configured to connect to one of the plurality of conductors; wherein two of the first conductor differential signal ends of the pair of first differential signal terminals are located between the first conductor data end and the conductor command end, and the two of the second conductor differential signal ends of the pair of second differential signal terminals are located between the conductor clock end and the second conductor data end.

Optionally, a distance between the two of the first conductor differential signal ends is equal to a distance between one of the two of the first conductor differential signal ends and the first conductor data end or a distance between one of the two of the first conductor differential signal ends and the conductor command end.

Optionally, a distance between the two of the second conductor differential signal ends is equal to a distance between one of the two of the second conductor differential signal ends and the second conductor data end or a distance between one of the two of the second conductor differential signal ends and the conductor clock end.

Optionally, the external device is a secure digital (SD) card complying with ultra high speed (UHS) specification.

According to still another embodiment of the present disclosure, a connector comprises a metal shell, an insulting shell assembled on the metal shell, a plurality of terminals positioned on the insulating shell, and a push-pull device configured to be moved toward the plurality of terminals when a flat cable is positioned inside the insulating shell such that the flat cable presses the plurality of terminals.

According to still another embodiment of the present disclosure, a connector comprises a shell and a plurality of terminals. The plurality of terminals comprises a ground terminal, a first data terminal, a pair of first differential signal terminals, a command terminal, a clock terminal, a pair of second differential signal terminals, and a second data terminal. The ground terminal includes a plurality of external device ground ends and a conductor ground end. Each of the plurality of external device grounding ends is configured to connect to a ground pin of an external device and the conductor ground end is configured to connect to one of the plurality of the conductors. The first data terminal includes a first external device data end and a first conductor data end. The first external data end is configured to connect to a first data signal pin of the external device and the first conductor data end is configured to connect to one of the plurality of conductors. Each of the first differential signal terminals comprises a first external device differential signal end and a first conductor differential signal end. The first external device differential signal end is configured to connect to a first differential signal pin of the external device and the first conductor differential signal end is configured to connect to one of the plurality of conductors. The command terminal includes an external device command end and a conductor command end. The external device command end is configured to connect to a command pin of the external device and the conductor command end is configured to connect to one of the plurality of conductors. The clock terminal includes an external device clock end and a conductor clock end. The external device clock end is configured to connect to a clock pin of the external device and the conductor clock end is configured to connect to one of the plurality of conductors. Each of the second differential signal terminals comprising a second external device differential signal end and a second conductor differential signal end. The second external device differential signal end is configured to connect to a second differential signal pin of the external device and the second conductor differential signal end is configured to connect to one of the plurality of conductors. The second data terminal includes a second external device data end and a second conductor data end. The second external data end is configured to connect to a second data signal pin of the external device and the second conductor data end is configured to connect to one of the plurality of conductors. Two of the first conductor differential signal ends of the pair of first differential signal terminals are located between the first conductor data end and the conductor command end, and the two of the second conductor differential signal ends of the pair of second differential signal terminals are located between the conductor clock end and the second conductor data end.

In contrast to a conventional art, the connector fixing structure according to an embodiment of the present disclosure could simplify the assembly steps and reduce the cost. In addition, because the flexible cable is movable, the flexible cable could be easily plugged/unplugged or replaced. Further, the flexible cable could be stably connected to the connector and will not be loosen or fell off because of shaking. In addition, the ground terminal is connected to ground ends of multiple external devices according to an embodiment of the present disclosure. Therefore, the number of the ground terminal could be reduced. Moreover, because the two first conductor differential signal ends are located between the first conductor date end and the conductor command end and the two second conductor differential signal ends are located between the second conductor clock end and the second conductor data end, there is no other terminal between the pair of first differential signal terminals and the pair of second differential signal terminals. Therefore, when the high frequency signals transferred by the pair of first differential signal terminals and the pair of second differential signal terminals are not affected by other terminals and thus the high frequency differential signals could have a better performance.

### BRIEF DESCRIPTION OF THE SEVERAL VIEWS OF THE DRAWINGS

FIG. 1 is a diagram of a conductor fixing structure and an electronic memory card according to an embodiment of the present disclosure.

FIG. 2A and FIG. 2B depict explosion diagrams of a conductor fixing structure in opposite view angles according to an embodiment of the present disclosure.

FIG. 3 depicts an insulating shell, terminals and a push-pull device shown in FIGS. 2A-2B.

FIG. 4 depicts an insulating shell, terminals and a cable shown in FIGS. 2A-2B.

FIG. 5A and FIG. 5B respectively depicts two operating statuses of the push-pull device.

FIG. 6 is a diagram of a structure after the push-pull device moves toward to the terminals when the cable is into the insulating shell.

FIG. 7 is a diagram of an electronic memory card.

FIG. 8A is a diagram of a structure of terminals according to a first embodiment of the present disclosure.

FIG. 8B is a diagram of a structure of terminals according to a second embodiment of the present disclosure.

FIG. 8C is a diagram of a structure of terminals according to a third embodiment of the present disclosure.

FIG. 9 is a diagram of a structure of terminals according to a fourth embodiment of the present disclosure.

FIG. 10 is a side view of a writing protection terminal installed in the insulating shell.

### DESCRIPTION OF SPECIFIC EMBODIMENTS OF THE INVENTION

Specifically, the terminologies in the embodiments of the present disclosure are merely for describing the purpose of the certain embodiment, but not to limit the invention. Examples and the appended claims be implemented in the present disclosure requires the use of the singular form of the book “an”, “the” and “the” are intended to include most forms unless the context clearly dictates otherwise. It should also be understood that the terminology used herein that “and/or” means and includes any or all possible combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

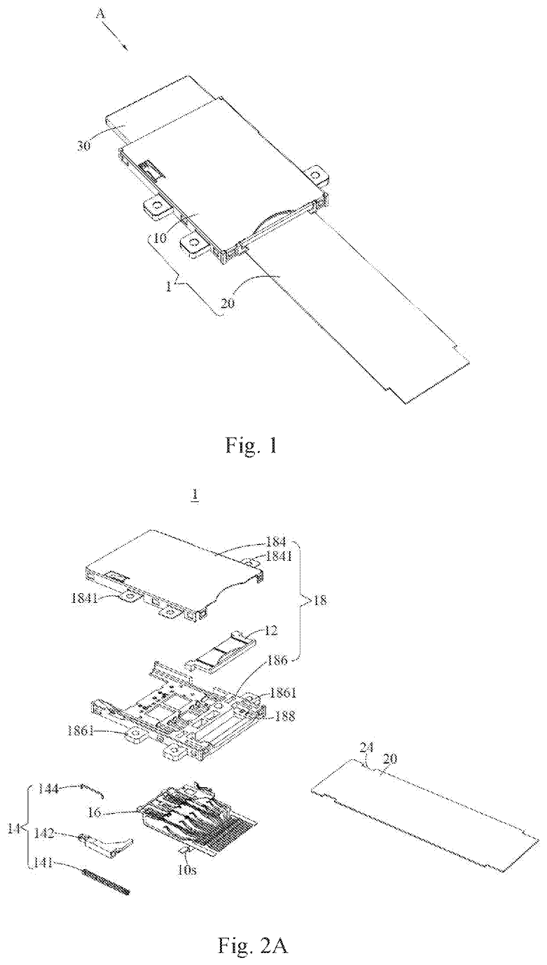

Please refer to FIG. 1. FIG. 1 is a diagram of a conductor fixing structure 1 and an electronic memory card 30 according to an embodiment of the present disclosure. The conductor fixing structure 1 is used in an electronic device, such as desktop, a laptop, a tablet, etc. The connector fixing structure 1 comprises a connector 10 and a cable 20. The connector 10 could be used to insert an external device such as a memory card 30 complying with the secure digital (SD) specification. The SD card specification comprises standard SD, MicroSD, MiniSD, SDHB, ultra high speed (UHS) specifications. The electronic memory card 30 could be inserted into the connector 10 in direction 40. The cable 20 is inserted in the connector 10 such that the electronic device could access the data stored in the electronic memory card through the cable 20 and the connector 10. In this embodiment, the cable 20 could be a Flex Cable, Flexible Flat Cable (FFC), or flexible circuit board (FPC).

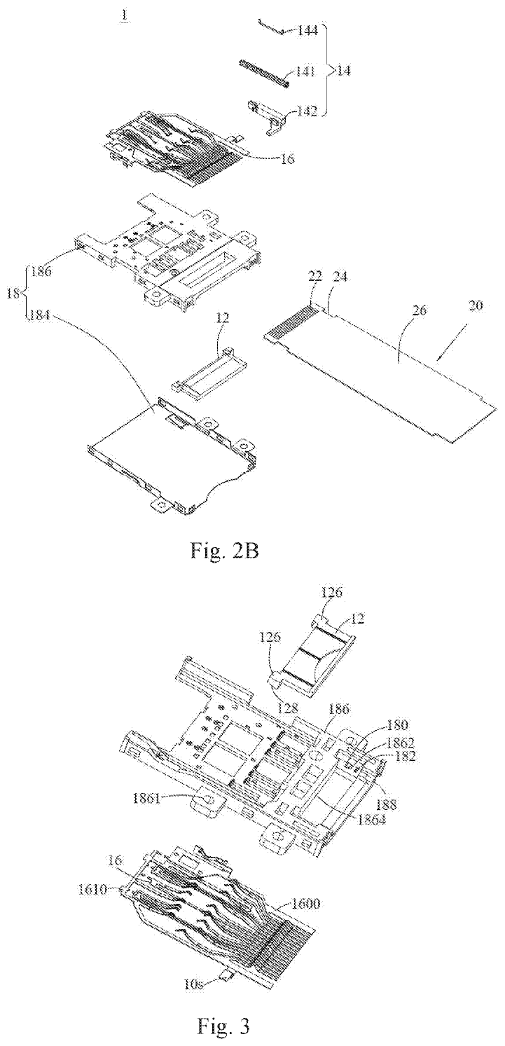

Please refer to FIG. 2A and FIG. 2B. FIG. 2A and FIG. 2B depict explosion diagrams of the conductor fixing structure 1 in opposite view angles according to an embodiment of the present disclosure. The cable 20 comprises a plurality of conductors 22. Each conductor 22 is insulated by an insulating layer 26. The connector 10 comprises a push-pull device 12, a retreating mechanism 14, a plurality of terminals 16, and a shell 16. The shell 18 comprises a metal shell 184 and an insulating shell 184. The insulating shell 186 is installed on the metal shell 184. The metal shell 184 comprises a plurality of positioning holes 1841. The insulating shell 186 comprises a plurality of fixing holes 1861. Screws (not shown) could be used to fix the metal shell 184 with the insulating shell 186 through the positioning holes 1841 and the fixing holes 1861. Also, screws could be used to fix the metal shell 184 and the insulating shell 186 on a substrate (not shown) or a printable circuit board (not shown). The multiple terminals 16 are installed on the insulating shell 186. When the cable is put inside the insulating shell 186, the push-pull device 16 is moved toward the terminals 16 such that the multiple conductors 22 of the cable 20 push the multiple terminals 16. The retreating mechanism 14 comprises a string 141, a locking unit 142 and a pull pin 144. The string is installed inside the locking unit 142. The pull pin hooks the locking unit 142. When the electronic memory card 20 is inserted into the connector 10, the locking unit 142 of the retreating mechanism 14 locks the electronic memory card 30 to prevent the memory card 30 from dropping out of the connector 10.

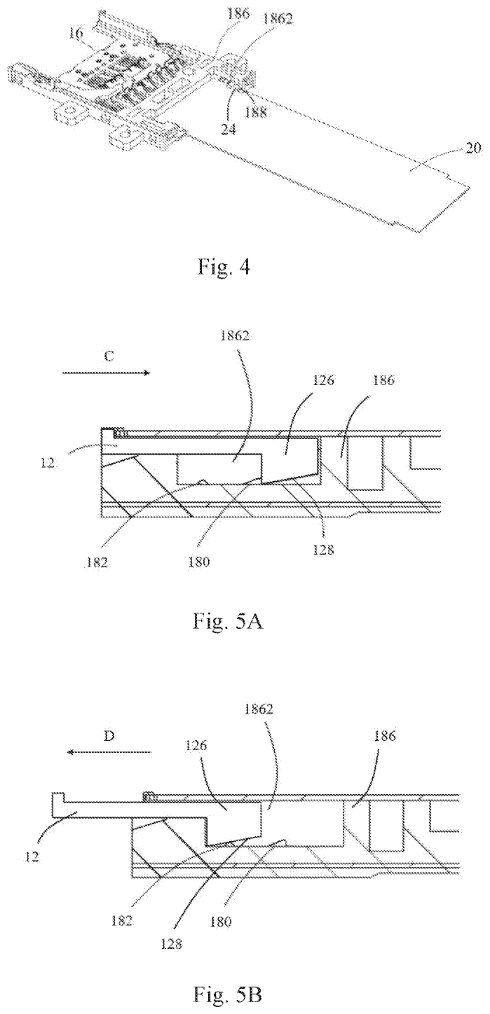

Please refer to FIG. 3 in conjunction with FIG. 4. FIG. 3 depicts the insulating shell 186, the terminals 16 and the push-pull device 12 shown in FIGS. 2A-2B. FIG. 4 depicts the insulating shell 186, the terminals 16 and the cable 20 shown in FIG. 2A-2B. The insulating shell 186 has two blocking units 188 at the cable entrance. The cable 20 has a cable trench 24 at each of the two long sides. The size of the cable trench 24 of the cable 20 matches the size of the block units 188 of the insulating shell 186. The cable trench 24 is clamped to the blocking units 188 such that the cable's movement is restricted. When the cable 20 is placed inside the insulating shell 186, the blocking unit 188 of the insulating shell 186 blocks the cable 20 such that the cable 20 cannot easily move from the insulating shell 186.

Please refer to FIGS. 2A-2B in conjunction with FIG. 3. The insulating shell 186 has a card slot 1862 and multiple terminals 1864. The bottom of the card slot 1862 has a first inosculating unit 180 and a second inosculating unit 182. Each terminal 16 could pass through a corresponding terminal hole 1864 to be arranged on the insulating shell 186. The multiple terminal holes 1864 are arranged with a constant pitch. The push-pull device 12 comprises two ending blocks 126. Each ending blocks 126 has a clamping unit 128. The size of the ending blocks is designed to allow the push-pull device 12 to move in the card slot 1862.

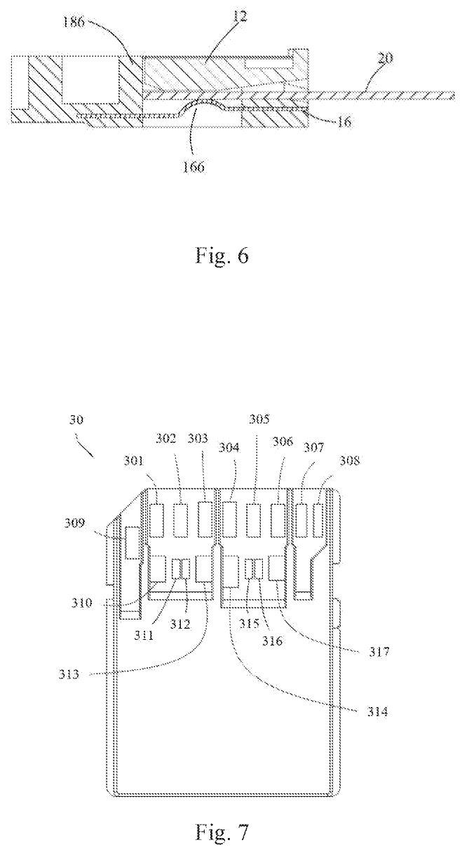

Please refer to FIGS. 3, 5A, 5B and 6. FIG. 5A and FIG. 5B respectively depicts two operating statuses of the push-pull device 12. FIG. 6 is a diagram of a structure after the push-pull device 12 moves toward to the terminals 16 when the cable 20 is into the insulating shell 186. The push-pull device 12 could be moved back or forth relatively to the insulating shell 186. Specifically, when the push-pull device 12 is pushed into the insulating shell 186 along the C direction, the ending blocks 126 moves in the card trenches 1862 along the C direction as well until the clamping unit 128 is pressed by the first inosculating unit 180. At this time, the conductor 22 of the cable 20 and the bending part 166 of the terminal 16 directly touches each other due to the pressure of the push-pull device 12 as shown in FIG. 6. Therefore, the cable 20 can be electrically connected to the terminal 16. After this, when the push-pull device 12 is pulled out along the D direction, the push-pull device 12 is partially uncovered by the insulating shell 186. At this time, the second clamping unit 128 is pressed upward by the second inosculating unit 182 such that the push-pull device 12 does not press the cable 20 and the terminal 16. Therefore, the cable 20 is not electrically connected to the terminal 16.

In this embodiment, the clamping unit 128 is a protruding downward structure of the push-pull device 12. The first inosculating unit 180 and the second inosculating unit 182 are protruding upward structures of the insulating shell 186, which press the clamping unit 128. In another embodiment, the clamping unit 128 could be a protrusion of the push-pull device 12 and the first inosculating unit 180 and the second inosculating unit 182 could be grooves of the insulating shell 186, which can be inosculated with the clamping unit 128. In this embodiment, because the clamping unit 128 and the first inosculating unit 180 could press each other such that the clamping unit 128 could be fixed with the insulating shell 186. In addition, in this embodiment, the clamping unit 128 is a structure having a slope surface. When the push-pull device 12 is pulled out (along the D direction), the second inosculating unit 182 presses the slope surface upward such that the cable 20 and the terminal 16 is not pushed by the push-pull device 12. This makes it easier to remove the cable. The shape of the clamping 128 could be determined by different design demands and could be a rectangular, half round, or half oval. The shapes of the first inosculating unit 180 and the second inosculating unit 182 could be determined by different design demands as well and could be any shape corresponding to the clamping unit 128.

As to the assembly of the cable 20 and the connector 10, the terminal 16 can be combined with the insulating shell 186 and then the cable 20 is placed on the insulating shell 186 such that the cable trench 24 and the blocking unit 188 of the insulating shell 186 could be clamped together. And then, the push-pull device 12 is positioned at the position shown in FIG. 5B. At last, the metal shell 184 and the insulating shell 186 are fixed together such that the assembly of the cable 20 and the connector 10 is completed. In another embodiment, the cable 20 could be inserted into the connector 10 through the gap between the insulating shell 186 and the push-pull 12. Then, the push-pull device 12 is pushed along the C direction such that the connection of the cable 20 and the connector 10 is completed. At the same time, by clamping the cable trench 24 with the blocking units 188 of the insulating shell 186, the connection of the cable 20 and the connector 10 could become more reliable.

Please refer to FIG. 7. FIG. 7 is a diagram of an electronic memory card 30. In this embodiment, the electronic memory card 30 complies with ultra-high speed (UHS) specification. Thus, the electronic memory card 30 comprises four data signal pins 301, 307, 308 and 309, a command pin 302, two power signal pins 304 and 314, a clock pin 305, five ground pins 303, 306, 310, 313, and 317, a pair of first differential signal pins 311 and 312, a pair of second differential signal pins 315 and 316, four data signal pints 301, 307, 308 and 309. The four data signal pints 301, 307, 308 and 309 are used to transfer 4-bit data. The command pin 302 is used to transfer the command. The power signal pin 304 is used to transfer a first power voltage, such as 3.3V. The power signal pin 314 is used to transfer a second power voltage, such as 1.8V. The clock pin 305 is used to transfer a clock signal. The five ground pins 303, 306, 310, 313, and 317 are used to transfer a ground voltage. The pair of first differential signal pins 311 and 312 are used to transfer a first low-voltage differential signal (LSDV). The pair of second differential signal pins 315 and 316 are used to transfer a second low-voltage differential signal (LSDV). Therefore, the electronic memory card 30 could have a higher bus speed. The first line of pins 301-309 are used to support a normal bus interface and the second line of pins 310-317 are used to support a UHS-II bus interface.

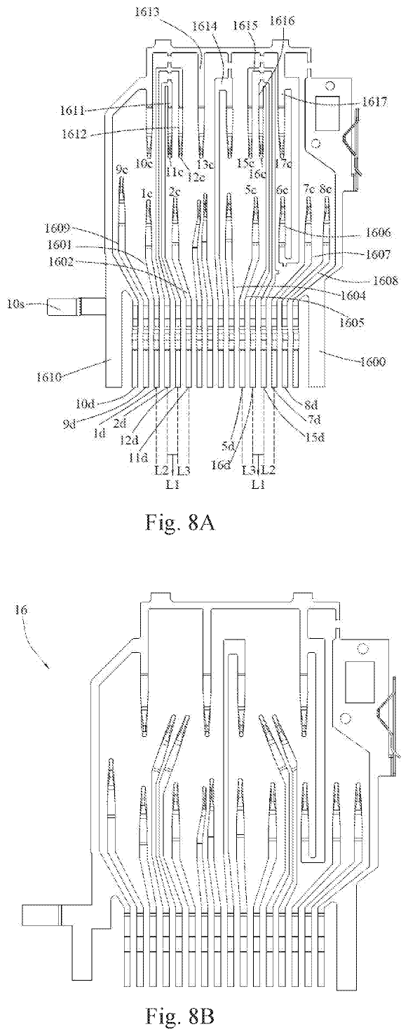

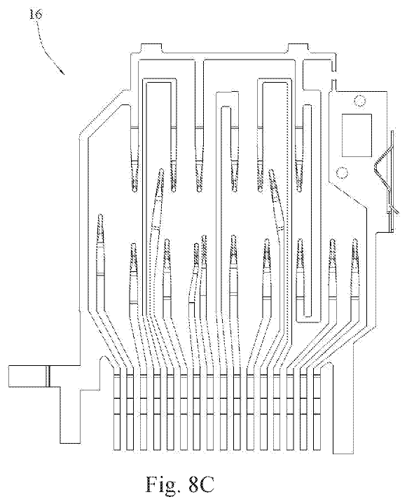

Please refer to FIG. 7 and FIG. 8A-FIG. 8C. FIG. 8A is a diagram of a structure of terminals 16 according to a first embodiment of the present disclosure. FIG. 8B is a diagram of a structure of terminals 16 according to a second embodiment of the present disclosure. FIG. 8C is a diagram of a structure of terminals 16 according to a third embodiment of the present disclosure. The plurality of terminals comprise ground terminals 1610, 1613, 1606, and 1617, data terminals 1601, 1607, 1608, and 1609, a pair of first differential signal terminals 1611 and 1612, a command terminal 1602, a clock terminal 1605, a pair of second differential signal terminals 1615 and 1616, power voltage terminals 1604 and 1614 and a writing protection terminal 1600. The ground terminal 1610 comprises a plurality of external device ground ends 6c, 10c, 13c, and 17c and a conductor ground end 10d. The plurality of external device grounding ends 6c, 10c, 13c, and 17c are respectively configured to connect to ground pins 306, 310, 313 and 317 of the electronic memory card 30. The conductor ground end 10d is configured to connect to one of the plurality of the conductors 22 of the cable 20. The first data terminal 1601 comprises a first external device data end 1c and a first conductor data end 1d. The first external data end 1c is configured to connect to a first data signal pin 301 of the electronic memory card 30. The first conductor data end 1d is configured to connect to one of the plurality of conductors 22. The second data terminal 1607 comprises a second external device data end 2c and a second conductor data end 7d. The second external data end 7c is configured to connect to a second data signal pin 307 of the electronic memory card 30. The second conductor data end 7d is configured to connect to one of the plurality of conductors 22. The third data terminal 1609 comprises a third external device data end 9c and a third conductor data end 9d. The third external data end 9c is configured to connect to a third data signal pin 309 of the electronic memory card 30. The third conductor data end 9d is configured to connect to one of the plurality of conductors 22. The fourth data terminal 1608 comprises a fourth external device data end 8c and a fourth conductor data end 8d. The fourth external data end 8c is configured to connect to a fourth data signal pin 308 of the electronic memory card 30. The fourth conductor data end 8d is configured to connect to one of the plurality of conductors 22. The pair of first differential signal terminals 1611 and 1612 respectively comprise first external device differential signal ends 11c and 12c and first conductor differential signal ends 11d and 12d. The first external device differential signal ends 11c and 12c are configured to connect to a first differential signal pins 311 and 312 of the electronic memory card 30. Each of the first conductor differential signal ends 11d and 12d is respectively configured to connect to one of the plurality of conductors 22. The command terminal 1602 comprises an external device command end 2c and a conductor command end 2d. The external device command end 2c is configured to connect to a command pin 302 of the electronic memory card 30. The conductor command end 2d is configured to connect to one of the plurality of conductors 22. The clock terminal 1605 comprises an external device clock end 5c and a conductor clock end 5d. The external device clock end 5c is configured to connect to a clock pin 305 of the electronic memory card 30. The conductor clock end 5d is configured to connect to one of the plurality of conductors 22. The pair of second differential signal terminals 1515 and 1616 respectively comprise second external device differential signal ends 15c and 16c and second conductor differential signal ends 15d and 16d. The second external device differential signal ends 15c and 16c are configured to connect to second differential signal pins 315 and 316 of the electronic memory device 30. Each of the second conductor differential signal ends is configured to connect to one of the plurality of conductors 22. The ground terminal 1610 comprises a shell contact end 10s.

In this embodiment, two of the first conductor differential signal ends 11d and 12d of the pair of first differential signal terminals 1611 and 1612 are located between the first conductor data end 1d and the conductor command end 2d. The two of the second conductor differential signal ends 15d and 16d of the pair of second differential signal terminals 1615 and 1616 are located between the conductor clock end 5d and the second conductor data end 7d. A distance L1 between the two of the first conductor differential signal ends 11d and 12d is equal to a distance L2 between the first conductor differential signal end 12d and the first conductor data end 1d or a distance L3 between the first conductor differential signal end 11d and the conductor command end 2d. A distance L1 between the two of the second conductor differential signal ends 15d and 16d is equal to a distance L2 between the second conductor differential signal end 15d and the second conductor data end 7d or a distance L3 between the second conductor differential signal end 16d and the conductor clock end 5d. Specifically, the distances L1, L2 and L3 are all equal. In another embodiment, the distance between any two adjacent terminals 16 at the side where the terminals 16 connect to the cable 22 is equal. The difference between FIGS. 8B and 8C and FIG. 8A is the bending way of the first differential signal terminals 1611 and 1612 and the second differential signal terminals 1615 and 1616. All the other characteristics are all the same as FIG. 8A and thus further illustrations are omitted here.

Please refer to FIGS. 2A, 2B, 3, and 8A-8C. When the metal shell 184 is fixed with the insulating shell, the shell contact end 10s contacts the metal shell 184. Because the metal shell 184 is grounded, the ground terminal 1610 is connected to the ground voltage as well.

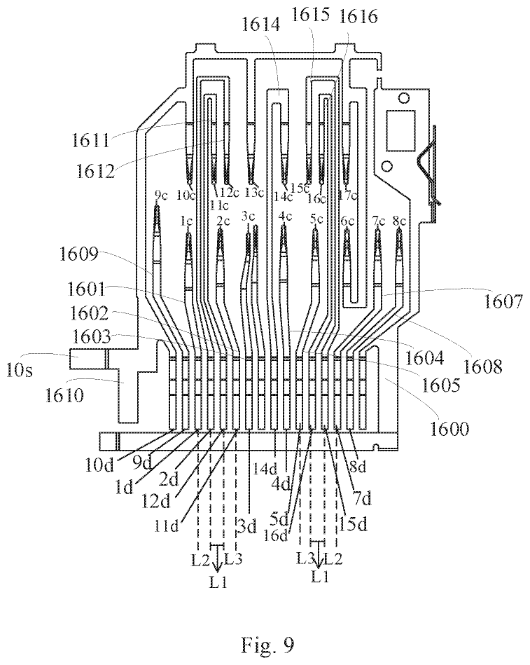

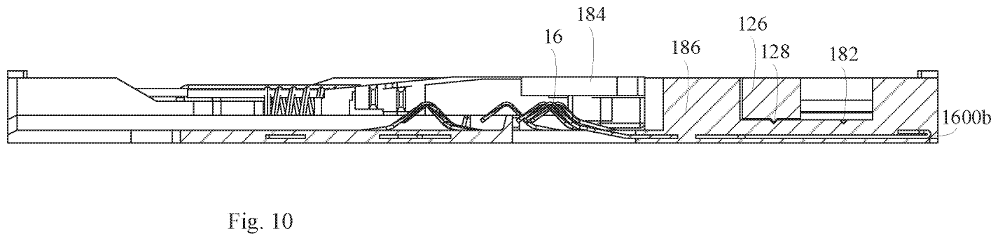

Please refer to FIG. 9 and FIG. 10. FIG. 9 is a diagram of a structure of terminals according to a fourth embodiment of the present disclosure. FIG. 10 is a side view of a writing protection terminal installed in the insulating shell. The writing protection terminal 1600 comprises a bending end 1600b. The bending end 1600b has a U shape for strengthening the structure of the shell 18. In this way, the writing protection terminal 1600 could be ensured to be fixed with the insulating shell 186.

In sum, the connector fixing structure according to an embodiment of the present disclosure could simplify the assembly steps and reduce the cost. In addition, because the flexible cable is movable, the flexible cable could be easily plugged/unplugged or replaced. Further, the flexible cable could be stably connected to the connector and will not be loosen or fell off because of shaking. In addition, the ground terminal is connected to ground ends of multiple external devices according to an embodiment of the present disclosure. Therefore, the number of the ground terminal could be reduced. Moreover, because the two first conductor differential signal ends are located between the first conductor date end and the conductor command end and the two second conductor differential signal ends are located between the second conductor clock end and the second conductor data end, there is no other terminal between the pair of first differential signal terminals and the pair of second differential signal terminals. Therefore, when the high frequency signals transferred by the pair of first differential signal terminals and the pair of second differential signal terminals are not affected by other terminals and thus the high frequency differential signals could have a better performance.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A connector fixing structure, comprising:
a cable, comprising a plurality of conductors; and
a connector, comprising:
a metal shell;
an insulting shell;
a plurality of terminals, positioned on the insulating shell; and
a push-pull device, configured to be moved toward the plurality of terminals when the cable is positioned inside the insulating shell such that the plurality of conductors presses the plurality of terminals.

2. The connector fixing structure of claim 1, wherein the cable is a flexible cable or a flexible circuit board.

3. The connector fixing structure of claim 1, wherein the plurality of terminals comprise:
a ground terminal, comprising a plurality of external device ground ends and a conductor ground end, wherein each of the plurality of external device grounding ends is configured to connect to a ground pin of an external device and the conductor ground end is configured to connect to one of the plurality of the conductors;
a first data terminal, comprising a first external device data end and a first conductor data end, wherein the first external data end is configured to connect to a first data signal pin of the external device and the first conductor data end is configured to connect to one of the plurality of conductors;
a pair of first differential signal terminals, each of the pair of first differential terminals comprising a first external device differential signal end and a first conductor differential signal end, wherein the first external device differential signal end is configured to connect to a first differential signal pin of the external device and the first conductor differential signal end is configured to connect to one of the plurality of conductors;
a command terminal, comprising an external device command end and a conductor command end, wherein the external device command end is configured to connect to a command pin of the external device and the conductor command end is configured to connect to one of the plurality of conductors;
a clock terminal, comprising an external device clock end and a conductor clock end, wherein the external device clock end is configured to connect to a clock pin of the external device and the conductor clock end is configured to connect to one of the plurality of conductors;
a pair of second differential signal terminals, each of the pair of second differential terminals comprising a second external device differential signal end and a second conductor differential signal end, wherein the second external device differential signal end is configured to connect to a second differential signal pin of the external device and the second conductor differential signal end is configured to connect to one of the plurality of conductors; and
a second data terminal, comprising a second external device data end and a second conductor data end, wherein the second external data end is configured to connect to a second data signal pin of the external device and the second conductor data end is configured to connect to one of the plurality of conductors;
wherein two of the first conductor differential signal ends of the pair of first differential signal terminals are located between the first conductor data end and the conductor command end, and the two of the second conductor differential signal ends of the pair of second differential signal terminals are located between the conductor clock end and the second conductor data end.

4. The connector fixing structure of claim 3, wherein a distance between the two of the first conductor differential signal ends is equal to a distance between one of the two of the first conductor differential signal ends and the first conductor data end or a distance between one of the two of the first conductor differential signal ends and the conductor command end.

5. The connector fixing structure of claim 3, wherein a distance between the two of the second conductor differential signal ends is equal to a distance between one of the two of the second conductor differential signal ends and the second conductor data end or a distance between one of the two of the second conductor differential signal ends and the conductor clock end.

6. The connector fixing structure of claim 1, wherein the external device is a secure digital (SD) card complying with ultra high speed (UHS) specification.

7. The connector fixing structure of claim 1, further comprising:
a writing protection terminal, comprising a bending end, wherein the bending end is U-shaped.

8. The connector fixing structure of claim 1, wherein the push-pull device comprises a clamping block, the insulating shell comprises a first inosculating unit, and the clamping block of the push-pull device is inosculated into the first inosculating unit after the push-pull device moves toward the plurality of terminals.

9. The connector fixing structure of claim 8, wherein the insulating shell further comprises a second inosculating unit, closer to the plurality of terminals in contrast to the first inosculating unit, and the clamping block of the push-pull device is inosculated into the second inosculating unit after the push-pull device moves backward the plurality of terminals.

10. The connector fixing structure of claim 3, wherein the ground terminal further comprises a shell contact end, and the shell contact end touches the metal shell.

11. A connector fixing structure, comprising:
a cable, comprising a plurality of conductors; and
a connector, comprising:
a shell; and
a plurality of terminals, comprising:
a ground terminal, comprising a plurality of external device ground ends and a conductor ground end, wherein each of the plurality of external device grounding ends is configured to connect to a ground pin of an external device and the conductor ground end is configured to connect to one of the plurality of the conductors;
a first data terminal, comprising a first external device data end and a first conductor data end, wherein the first external data end is configured to connect to a first data signal pin of the external device and the first conductor data end is configured to connect to one of the plurality of conductors;
a pair of first differential signal terminals, each of the first differential signal terminals comprising a first external device differential signal end and a first conductor differential signal end, wherein the first external device differential signal end is configured to connect to a first differential signal pin of the external device and the first conductor differential signal end is configured to connect to one of the plurality of conductors;
a command terminal, comprising an external device command end and a conductor command end, wherein the external device command end is configured to connect to a command pin of the external device and the conductor command end is configured to connect to one of the plurality of conductors;
a clock terminal, comprising an external device clock end and a conductor clock end, wherein the external device clock end is configured to connect to a clock pin of the external device and the conductor clock end is configured to connect to one of the plurality of conductors;
a pair of second differential signal terminals, each of the second differential signal terminals comprising a second external device differential signal end and a second conductor differential signal end, wherein the second external device differential signal end is configured to connect to a second differential signal pin of the external device and the second conductor differential signal end is configured to connect to one of the plurality of conductors; and
a second data terminal, comprising a second external device data end and a second conductor data end, wherein the second external data end is configured to connect to a second data signal pin of the external device and the second conductor data end is configured to connect to one of the plurality of conductors;
wherein two of the first conductor differential signal ends of the pair of first differential signal terminals are located between the first conductor data end and the conductor command end, and the two of the second conductor differential signal ends of the pair of second differential signal terminals are located between the conductor clock end and the second conductor data end.

12. The connector fixing structure of claim 11, wherein a distance between the two of the first conductor differential signal ends is equal to a distance between one of the two of the first conductor differential signal ends and the first conductor data end or a distance between one of the two of the first conductor differential signal ends and the conductor command end.

13. The connector fixing structure of claim 11, wherein a distance between the two of the second conductor differential signal ends is equal to a distance between one of the two of the second conductor differential signal ends and the second conductor data end or a distance between one of the two of the second conductor differential signal ends and the conductor clock end.

14. The connector fixing structure of claim 11, wherein the external device is a secure digital (SD) card complying with ultra high speed (UHS) specification.

15. The connector fixing structure of claim 11, wherein the shell comprises:
a metal shell; and
an insulating shell, assembled on the metal shell;
wherein the ground terminal further comprises a shell contact end and the shell contact end contacts the metal shell.

16. The connector fixing structure of claim 11, further comprising:
a writing protection terminal, comprising a bending end, wherein the bending end is U-shaped.

17. The connector fixing structure of claim 11, further comprising:
a push-pull device, configured to be moved toward the plurality of terminals when the cable is positioned inside the insulating shell such that the plurality of conductors presses the plurality of terminals.

18. A connector, comprising:
a metal shell;
an insulting shell, assembled on the metal shell;
a plurality of terminals, positioned on the insulating shell; and
a push-pull device, configured to be moved toward the plurality of terminals when a flat cable is positioned inside the insulating shell such that the flat cable presses the plurality of terminals.

19. The connector of claim 18, wherein the plurality of terminals comprise:
a ground terminal, comprising a plurality of external device ground ends and a conductor ground end, wherein each of the plurality of external device grounding ends is configured to connect to a ground pin of an external device and the conductor ground end is configured to connect to one of the plurality of the conductors;
a first data terminal, comprising a first external device data end and a first conductor data end, wherein the first external data end is configured to connect to a first data signal pin of the external device and the first conductor data end is configured to connect to one of the plurality of conductors;
a pair of first differential signal terminals, each of the pair of first differential terminals comprising a first external device differential signal end and a first conductor differential signal end, wherein the first external device differential signal end is configured to connect to a first differential signal pin of the external device and the first conductor differential signal end is configured to connect to one of the plurality of conductors;
a command terminal, comprising an external device command end and a conductor command end, wherein the external device command end is configured to connect to a command pin of the external device and the conductor command end is configured to connect to one of the plurality of conductors;
a clock terminal, comprising an external device clock end and a conductor clock end, wherein the external device clock end is configured to connect to a clock pin of the external device and the conductor clock end is configured to connect to one of the plurality of conductors;
a pair of second differential signal terminals, each of the pair of second differential terminals comprising a second external device differential signal end and a second conductor differential signal end, wherein the second external device differential signal end is configured to connect to a second differential signal pin of the external device and the second conductor differential signal end is configured to connect to one of the plurality of conductors; and
a second data terminal, comprising a second external device data end and a second conductor data end, wherein the second external data end is configured to connect to a second data signal pin of the external device and the second conductor data end is configured to connect to one of the plurality of conductors;
wherein two of the first conductor differential signal ends of the pair of first differential signal terminals are located between the first conductor data end and the conductor command end, and the two of the second conductor differential signal ends of the pair of second differential signal terminals are located between the conductor clock end and the second conductor data end.

20. A connector, comprising:
a shell; and
a plurality of terminals, comprising:
a ground terminal, comprising a plurality of external device ground ends and a conductor ground end, wherein each of the plurality of external device grounding ends is configured to connect to a ground pin of an external device and the conductor ground end is configured to connect to one of the plurality of the conductors;
a first data terminal, comprising a first external device data end and a first conductor data end, wherein the first external data end is configured to connect to a first data signal pin of the external device and the first conductor data end is configured to connect to one of the plurality of conductors;
a pair of first differential signal terminals, each of the first differential signal terminals comprising a first external device differential signal end and a first conductor differential signal end, wherein the first external device differential signal end is configured to connect to a first differential signal pin of the external device and the first conductor differential signal end is configured to connect to one of the plurality of conductors;
a command terminal, comprising an external device command end and a conductor command end, wherein the external device command end is configured to connect to a command pin of the external device and the conductor command end is configured to connect to one of the plurality of conductors;
a clock terminal, comprising an external device clock end and a conductor clock end, wherein the external device clock end is configured to connect to a clock pin of the external device and the conductor clock end is configured to connect to one of the plurality of conductors;
a pair of second differential signal terminals, each of the second differential signal terminals comprising a second external device differential signal end and a second conductor differential signal end, wherein the second external device differential signal end is configured to connect to a second differential signal pin of the external device and the second conductor differential signal end is configured to connect to one of the plurality of conductors; and
a second data terminal, comprising a second external device data end and a second conductor data end, wherein the second external data end is configured to connect to a second data signal pin of the external device and the second conductor data end is configured to connect to one of the plurality of conductors;
wherein two of the first conductor differential signal ends of the pair of first differential signal terminals are located between the first conductor data end and the conductor command end, and the two of the second conductor differential signal ends of the pair of second differential signal terminals are located between the conductor clock end and the second conductor data end.
